(19) United States
(12) Patent Application Publication
(10) Pub. No.: US 2008/0092550 A1
(43) Pub. Date: Apr. 24, 2008

(54) Direct force instant hot water distribution system

(76) Inventor: William D. Folsom, Spring, TX (US)

Correspondence Address: MARY J. GASKIN;ANNELIN & GASKIN, 2170 BUCKTHORNE PL., SUITE 220, THE WOODLANDS, TX, 77380, US

(21) Appl. No.: 11/484,455

(22) Filed: Jul. 11, 2006

(51) Int. Cl. F02C 7/00

(52) U.S. Cl. 60/783

(57) ABSTRACT

A system for maintaining the heat of hot water circulating in hot water pipes. A generator mounted on the flue of a water heater converts exhaust heat from the water heater into electrical power, which is stored in a battery. The electrical power is used to power a circulating pump, which is activated when the temperature of the water in the hot water return pipe drops below a preset temperature; the circulating pump circulates through the water heater to keep it hot. In an alternative embodiment, the electrical power can be used to power heat tape, which has been applied to the outer surface of the hot water supply line in order to keep the water in the line hot. The system can be used with all gas-fired water heating systems, including tankless water heaters.

### FIELD OF THE INVENTION

The present invention relates to a system for keeping water hot while it is in the hot water piping system, without requiring the expenditure of power from outside the system.

### BACKGROUND OF THE INVENTION

Presently, water heaters are not designed to keep water hot after it has entered the hot water delivery system and the water heater cycles off. Consequently, the water in the hot water piping system will cool. For example, when a hot water tap is opened, several gallons of cold water will be wasted until the hot water from the water heater can be delivered to that particular tap. In addition, the person calling for hot water wastes time waiting for it to reach him.

Methods presently used to provide a more immediate delivery of hot water all require the expenditure of energy beyond that used to heat the water initially. The most common method requires the use of a circulating system, which is usually operated by a circulating pump. The circulating pump, which requires the expenditure of electrical power, continuously circulates the water through the hot water piping system, even when no one is calling for hot water. The water circulates back through the hot water heater tank, causing it to cycle on more often in order to reheat the circulating water, resulting in the expenditure of more energy. While the user may have instant hot water as soon as he opens the hot water tap, he will pay for it in the form of higher utility bills, and we all pay for it in the form of wasted energy. Even when a tankless water heater is used, the water in the line will go cold when the heater is in the “off” mode.

There exists a need for a system which can supply hot water immediately without requiring the use of energy beyond what an ordinary water heater system presently uses.

### SUMMARY OF THE INVENTION

The present invention incorporates a generator mounted on the flue of a water heater. The generator converts the exhaust heat from the water heater into electrical power. The electrical power generated is stored in a battery, which supplies power to either heat tape or a circulating pump in order to keep the water in the water pipes hot during the period when the water heater is in the “off” position of the cycle. As a result, the system can deliver hot water on demand, without “wasting” cold water and a user's time.

The present invention is designed to work on all gas-fired water heating systems, including tankless, or on-demand, water heaters.

Accordingly, it is an object of the present invention to provide an improved hot water delivery system which converts exhaust heat to electrical power, which is used to maintain the heat of hot water in the hot water piping system when the water heater is in the “off” mode.

Another object of the present invention is to provide a hot water delivery system which saves energy and water consumption.

Yet another object of the present invention is to provide a system which can be used with a consumer's original hotwater delivery system, without requiring expensive retrofitting of the pipes in the hot water delivery system.

Still another object of the present invention is to provide alternative methods of keeping water hot while it remains in the pipes of the hot water delivery system.

### BRIEF DESCRIPTION OF THE DRAWINGS

FIG. 1 is a flow diagram showing the components of the system of the present invention, which utilizes a circulating pump in order to keep water hot while it remains in a hot water delivery system.

FIG. 2 is a schematic view of the components of the system of the present invention acting in concert with the water flowing through a standard hot water delivery system which incorporates a circulating pump.

FIG. 3 is a flow diagram showing the components of an alternative system of the present invention, which utilizes heat tape in order to keep water hot while it remains in a hot water delivery system.

FIG. 4 is a schematic view of the components of an alternative system of the present invention, which uses heat tape to keep water hot while it remains in a hot water delivery system.

### DESCRIPTION OF THE PREFERRED EMBODIMENT

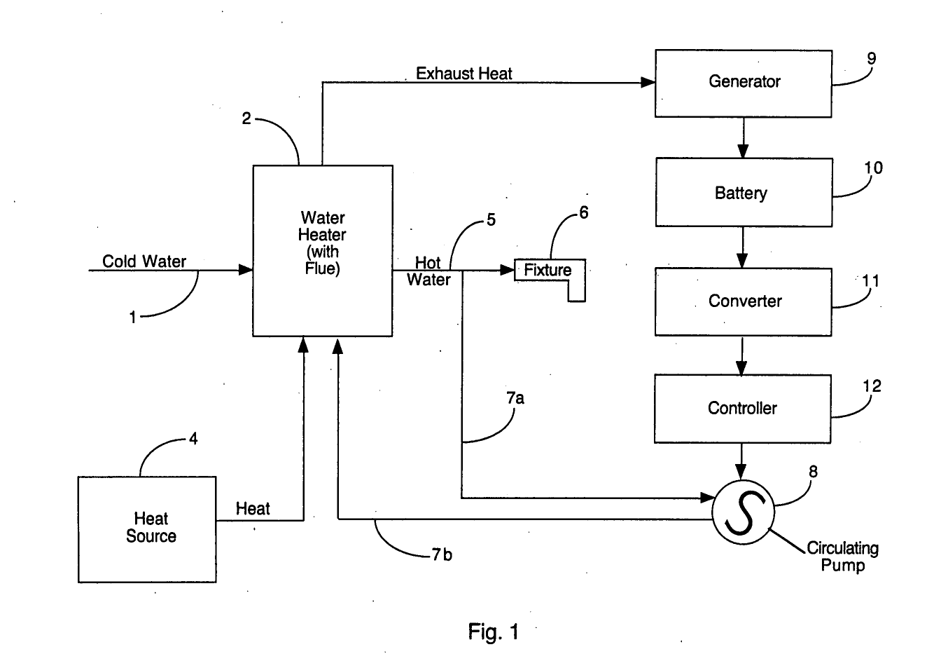

The operation of the system of the present invention can be seen in simplified FIG. 1. Cold water is piped through a main supply line 1 into a standard water heater 2 with a flue. A heat source 4 generates heat, which raises the temperature of the water in the water heater 2. Hot water leaving the water heater 2 can travel through hot water supply line 5 to a fixture 6 for delivery to a user calling for hot water, or it can travel through hot water return 7a, 7b through a circulating pump 8, which recirculates the water back to the water heater 2, where it is again heated. Electrical power for the circulating pump 8 is supplied in a novel way. Exhaust heat from the water heater 2 is converted into electricity by a generator 9. The electricity is stored in a battery 10, and a converter 11 converts DC power to AC power, which drives the circulating pump 8, which is controlled by a controller 12. Because the power to run the circulating pump 8 is generated from the exhaust heat from the water heater 2, the system operates without expending energy generated from outside the system.

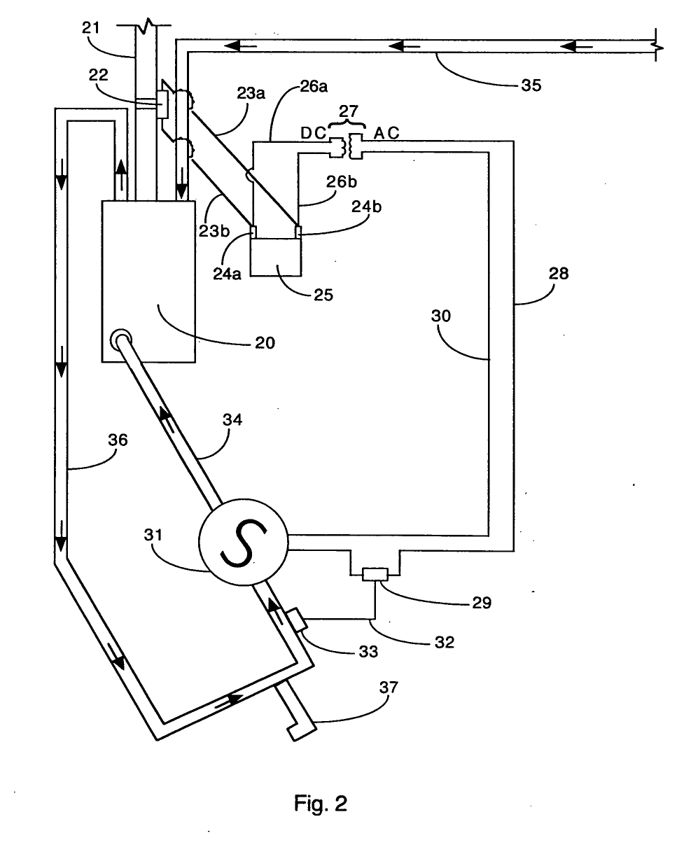

As shown in FIG. 2, the system of the present invention operates with a conventional tank-style water heater 20, which typically holds approximately 40 to 50 gallons of water. The water heater flue 21, under normal conditions, operates at approximately 350° F. The flow of warm flue gases vented from the flue 21, which would otherwise result in heat loss from the water heater 20, provides heat to a generator 22 which is affixed to the outside of the flue 21. The generator 22 can be any electricity-generating device capable of converting heat (in this application, waste heat) into electrical power. For example, it can be a thermoelectric generator, including the HZ-14 Thermoelectric module made by Hi-Z Technology, Inc.; or it can be a pyromagnetic generator like the one Thomas A. Edison described in his U.S. Pat. No. 476,983. The generator 22 is connected by lines 23a, 23b to the electrodes 24a, 24b of a battery 25, or fuel cell, which stores the electrical power. The lines 23a, 23b can be 12-strand, 24-gauge copper wire. The battery 25, or fuel cell, is rechargeable, and it produces 12 or 24 volts of direct current (DC). Lines 26a, 26b, also typically made from 12-strand,24-gauge copperwire, conduct the electrical powerfrom the battery 25 to a converter 27, or transformer, which converts direct current (DC) electricity into alternating current (AC) electricity, if necessary. (No converter is required if direct current electricity can be used to power the circulating pump 31.)

A line 28, also typically made from 12-strand, 24-gauge copper wire, runs from the converter 27 to a relay switch 29. A second line 30, also typically made from 12-strand, 24-gauge copper wire, runs from the converter 27 to a circulating pump 31. The relay switch 29, which is normally open, is linked by communication line 32, typically thermocouple wire, to a thermostat 33 (or another heat sensing device) on the water return line 34. The thermostat 33 is designed to close the circuit when the temperature of the water in the hot water system drops below a preset temperature (for example, below 100° F.). When the circuit is closed, electrical power activates the circulating pump 31.

The hot water delivery system flows in a conventional fashion. Cold water is piped through a cold water supply line 35 into the water heater 20, where it is heated when the water heater is in an “on” cycle. Heated water leaving the water heater travels through hot water supply line 36 to a fixture 37 for delivery to a user calling for hot water. Water not drained from the hot water supply line 36 travels through hot water return line 34 and through circulating pump 31, back to the water heater 20. However, in the system of the present invention, the circulating pump 31 is activated only when the water heater 20 is in the “off” cycle. Further, the electrical power to run the circulating pump 31 is generated by the exhaust heat from the water heater 20, not from sources outside the system.

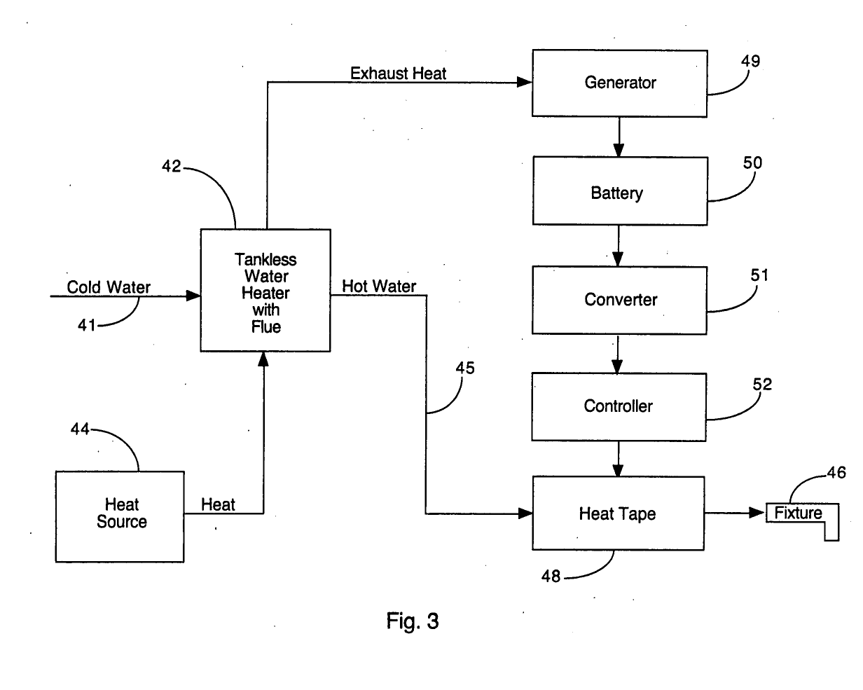

The operation of an alternative system of the present invention can be seen in simplified FIG. 3. Cold water is piped through a main supply line 41 into an on-demand, tankless water heater 42 with a flue. A heat source 44 generates heat, which raises the temperature of the water in the water heater 42. Hot water leaving the water heater 42 travels through hot water supply line 45 to a fixture 46 for delivery to a user calling for hot water. Heat tape 48 has been applied to the outer surface of the hot water supply line 45 in order to keep the water in the line hot. Electrical power for the heat tape 48 is supplied in a novel way. Exhaust heat from the water heater 42 is converted into electricity by a generator 49. The electricity is stored in a battery 50, and a converter 51 converts DC power to AC power, which powers the heat tape 48, which is activated by a controller 52. Because the power to heat the heat tape 48 is generated from the exhaust heat from the water heater 42, the system operates without expending energy generated from outside the system.

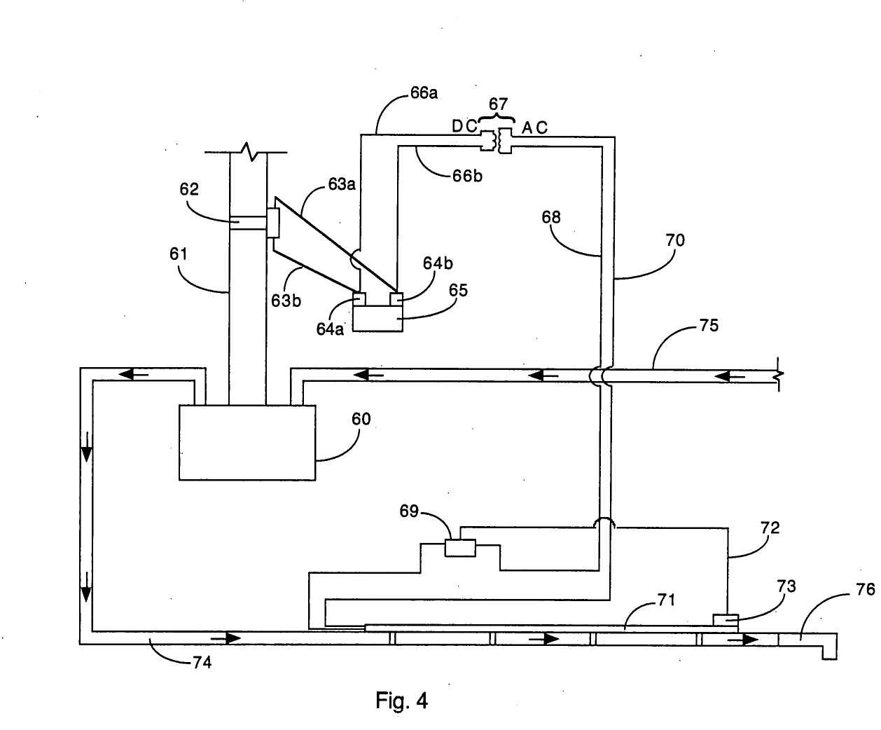

As shown in FIG. 4, the alternative system of the present invention operates with on-demand, tankless water heater 60. The water heater flue 61, under normal conditions, operates at approximately 350° F. The flow of warm flue gases vented from the flue 61, which would otherwise result in heat loss from the water heater 60, provides heat to a generator 62 which is affixed to the outside of the flue 61. The generator 62 can be any electricity-generating device capable of converting heat (in this application, waste heat) into electrical power. For example, it can be a thermoelectric generator, including the HZ-14 Thermoelectric module made by Hi-Z Technology, Inc.; or it can be a pyromagnetic generator like the one Thomas A. Edison described in his U.S. Pat. No. 476,983. The generator 62 is connected by lines 63a, 63b to the electrodes 64a, 64b of a battery 65, or fuel cell, which stores the electrical power. The lines 63a, 63b can be 12-strand, 24-gauge copper wire. The battery 65, or fuel cell, is rechargeable, and it produces 12 or 24 volts of direct current (DC). Lines 66a, 66b, also typically made from 12-strand, 24-gauge copper wire, conduct the electrical power from the battery 65 to a converter 67, or transformer, which converts direct current (DC) electricity into alternating current (AC) electricity, if necessary. (No converter is required if direct current electricity can be used to power the heat tape 71.)

A line 68, also typically made from 12-strand, 24-gauge copper wire, runs from the converter 67 to a relay switch 69. A second line 70, also typically made from 12-strand, 24-gauge copper wire, runs from the converter 67 to a length of heat tape 71. The heat tape used is typically a low-wattage, adhesive heat tape, such as one made by Clayborn, which can be wrapped around the water pipe or run along one side of a pipe. The relay switch 69, which is normally open, is linked by communication line 72, typically thermocouple wire, to a thermostat 73 (or another heat sensing device) on the hot water supply line 74. The thermostat 73 is designed to close the circuit when the temperature of the water in the hot water supply line 74 drops below a preset temperature (for example, below 100° F.). When the circuit is closed, electrical power activates the heat tape 71.

The hot water delivery system flows in a conventional fashion. Cold water is piped through a cold water supply line 75 into the water heater 60, where it is heated when the water is being called for by a user. Heated water leaving the water heater 60 travels through hot water supply line 74 to a fixture 76 for delivery to a user calling for hot water. The water remaining in the hot water supply line 71 will stay hot because the heat tape 71 will be activated when the temperature of the water falls below the preset temperature. The user gets hot water, yet saves money because the electrical power to power the heat tape 71 is generated by the exhaust heat from the water heater 60, not from sources outside the system.

The present system can be applied to electric water heating systems; however, the electricity needed to operate the circulating pump or the heat tape would have to be supplied from an outside source, since the electric water heating system has no hot exhaust gases or flue from which to generate electricity.

I claim:

1. A method of utilizing exhaust heat from a water heater with a flue in order to generate electricity which activates means used to keep water hot in a hot water distribution system when the water heater is in an “off” cycle.

2. The method of claim 1 wherein the electricity is stored in a fuel cell.

3. The method of claim 1 wherein the means used to keep the water hot is selected from the group consisting of a circulating pump and heat tape.

4. The method of claim 1 which further includes means of converting direct current into alternating current.

5. A system for converting exhaust heat from a water heater with a flue into electrical power in order to maintain the heat of hot water circulating through hotwater delivery pipes, the system comprising:
a generator affixed to the flue;
a rechargeable fuel cell;
wiring connecting the generator to the fuel cell;
a circulating pump;
wiring connecting the fuel cell to the circulating pump;
a relay switch;
a thermostat on a water return pipe;
means for linking the relay switch to the thermostat;
the thermostat being designed to close an electrical circuit when the water cools, electrical power from the fuel cell thereupon activating the circulating pump.

6. The system of claim 5, which further comprises:
a converter for converting direct current electricity into alternating current electricity;
wiring connecting the fuel cell to the converter.

7. A system for converting exhaust heat from a water heater with a flue into electrical power in order to maintain the heat of hot water in hot water delivery pipes, the system comprising:
a generator affixed to the flue;
a rechargeable fuel cell;
wiring connecting the generator to the fuel cell;
heat tape;
wiring connecting the fuel cell to the heat tape;
a relay switch;
a thermostat on a hot water delivery pipe;
means for linking the relay switch to the thermostat;
the thermostat being designed to close an electrical circuit when the water cools, electrical power from the fuel cell thereupon activating the heat tape.

8. The system of claim 7, which further comprises:
a converter for converting direct current electricity into alternating current electricity;
wiring connecting the fuel cell to the converter.
